(19) United States
(12) Patent Application Publication
(10) Pub. No.: US 2007/0289847 A1
(43) Pub. Date: Dec. 20, 2007

(54) Rubber Member Conveying Device and Rubber Member Supplying System with the Same

(75) Inventor: Mitsuo Nakamura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, CHUO-KU, TOKYO (JP)

(21) Appl. No.: 10/585,310

(22) PCT Filed: Jan. 5, 2005
(86) PCT No.: PCT/JP05/00006

§ 371 Date: Jul. 31, 2007

(30) Foreign Application Priority Data
Jan. 6, 2004 (JP) 2004-001331

(51) Int. Cl. B65G 47/00

(52) U.S. Cl. 198/617; 198/618; 198/752.1; 198/804

(57) ABSTRACT

A rubber member conveying device and a rubber member supplying system having the same are provided. The device and the system rapidly promote the shrinkage of the rubber member, thereby avoiding the length variation of the rubber member in the processing step for the rubber member. A rubber member supplying system 10 comprises a belt conveyor 14 which supplies a to-be-cut material 12 having an internal strain, a cutter 16 which cuts the to-be-cut material 12 supplied by the belt conveyor 14 to form a rubber member 20, and a rubber member conveying part 24 which conveys the rubber members 20. The rubber member conveying part 24 comprises an endless belt 26, and rollers 28 supported by supporting parts 30 that are provided at the endless belt 26. The rubber member 20 is conveyed on the rollers 28 while exposed to vibrations. Accordingly, the shrinkage in the rubber member 20 caused by the internal strain thereof is substantially completed in the conveying operation.

### TECHNICAL FIELD

The present invention relates to a rubber member conveying device which conveys a rubber member and a rubber member supplying system having the same, and more particularly, relates to a rubber member conveying device which is especially suitable for conveying an unvulcanized rubber member and a rubber member supplying system having the same.

### RELATED ART

For pneumatic tires, many types of rubber member, such as a tread rubber constituting a tread, or the like, are used (referring to Japanese Patent Laid-Open Publication No. 5-139127/1993, for example). These rubber members are formed by cutting a to-be-cut material having a long strip shape that is conveyed by a belt conveyor, or the like, to a certain length, and then each rubber member formed is further conveyed by a belt conveyor, or the like, to a position where it is used.

However, because the rubber member that has been cut may have a residual internal strain, shrinkage may be caused in the rubber member, resulting in the length being varied, which may prevent the subsequent processing step from being rapidly performed.

### DISCLOSURE OF THE INVENTION

### Subjects to be Solved by the Invention

The present invention has been made in view of the above, and the purpose thereof is to provide a rubber member conveying device and a rubber member supplying system having the same which promote the shrinkage of the rubber member, thereby preventing the length variation of the rubber member in the processing step for the rubber member.

### Means to Achieve the Subjects

The invention as recited in claim 1 provides a rubber member conveying device includes a vibration imparting part which imparts vibration to a rubber member having internal strain, and conveying part which conveys said rubber member. Said rubber member is conveyed by said conveying part while having vibration imparted to said rubber member by said vibration imparting part.

According to the invention as stated in claim 1, the rubber member having internal strain is conveyed by the conveying part while having vibration imparted by the vibration imparting part, thus the shrinkage of the rubber member that is induced by the internal strain is rapidly promoted by this vibration and almost completed during the conveyance. Therefore, the length variation of the rubber member can be avoided in the subsequent processing step for the rubber member, which allows the processing capability to be substantially improved. In addition, because the rubber member is conveyed with being vibrated, there is no need for providing an extra time period for imparting vibration.

The invention according to claim 2 recites that the vibration imparted to said rubber member by said vibration imparting part has a frequency of 5 to 100 Hz, an amplitude of 0.5 to 10 mm, and a time period of vibration of 1 sec or longer.

According to the above, the internal strain of the rubber member can be sufficiently relieved.

The invention as stated in claim 3 recites that said frequency, said amplitude, and said time period of vibration are set according to the thickness, hardness and amount of internal strain of said rubber member.

According to the above, in relieving the rubber member internal strain, the frequency or amplitude of vibration can be prevented from being unnecessarily high or large, and the vibration time period can be prevented from being unnecessarily long.

The invention as stated in claim 4 recites that said conveying part is provided with an rotating endless belt that is loaded with said rubber member, a protruding part is provided on a rubber member loading surface side of said endless belt as said vibration imparting part, and said rubber member is moved relatively to said protruding part due to rotation of said endless belt.

According to the above, the vibration imparting part can be formed extremely simple. In addition, when the endless belt rotates for conveyance, vibration is imparted to the rubber member and when running of the endless belt is stopped, no vibration is generated therefore, the vibration can be efficiently generated.

The invention as stated in claim 5 recites that, as said protruding part, a plurality of revolving elements which are held freely rotatably are provided, and when said endless belt rotates, said revolving elements which are butted against said rubber member are turned by a moving force of said endless belt and a friction force exerted by said rubber member.

According to the above, the rubber member is gradually conveyed by being moved relative to the revolving element due to the rotation of the revolving elements, and thus even if the conveying distance is short, the period of vibration of the rubber member can be sufficiently long to allow the device to be configured significantly compactly. In addition, the plurality of revolving elements disposed cause the conveyed rubber member to be undulated, and thus the rubber member is subjected to vibrations at every single part thereof, which allows the rubber member to be relieved of the internal strain at every single part thereof.

The invention as stated in claim 6 recites that, as said revolving elements, rollers are provided such that an axis of rotation thereof is in a direction orthogonal to a conveyance direction.

According to the above, the constitution of the vibration generation part can be formed further compact and simple, and a portion of the rubber member that might not be subjected to vibration can be almost thoroughly eliminated.

The invention as stated in claim 7 recites that, said revolving elements are ball bearings.

According to the above, as compared to the invention of claim 6, the constitution of the vibration generation part can be formed further compact and simple.

The invention as stated in claim 8 provides a rubber member supplying system comprising a delivery unit which delivers a to-be-cut material made of rubber having internal strain, a cutting unit which cuts said to-be-cut material supplied from said delivery unit, and the conveying device of any one of claims 1 to 7 that conveys a rubber member which has been cut by said cutting unit.

Even if a rubber member which has been produced by cutting the to-be-cut material with the cutting unit has internal strain because the to-be-cut material, which has been delivered by the delivery unit, has originally internal strain, the rubber member conveying device conveys the rubber member while imparting vibration thereto, thus the shrinkage of the rubber member that is induced by the internal strain can be almost completed during the conveyance.

Therefore, by using the rubber member supplying system of claim 8, the length variation of the rubber member in the processing step for the rubber member after the cutting can be substantially avoided, which allows the processing capability to be excellently improved. In addition, because the rubber member is conveyed while being vibrated, there is no need for providing an extra time period for imparting vibration.

The invention as stated in claim 9 recites that said delivery unit is capable of intermittent running, and when said cutting unit cuts a to-be-cut material, said delivery unit stops delivery of the to-be-cut material.

According to the above, the cutting can be performed excellently.

The invention as stated in claim 10 recites that said cut-to-be material is a long strip shaped material that is formed by the extrusion process.

An intermediate product having long strip shape and made of rubber can be easily formed by the extrusion process, however, when it is shaped by the extrusion process, internal strain may be caused therein. According to the invention as stated in claim 10, a to-be-cut material which has been easily formed by the extrusion process is cut and successively supplied to the rubber member conveying device resulting in efficient conveyance.

### EFFECTS OF THE INVENTION

The present invention is configured as described above, thus a rubber member conveying device and a rubber member supplying system having the same rapidly promote the shrinkage of the rubber member, thereby preventing the length variation of the rubber member in the processing step for the rubber member.

### BRIEF DESCRIPTION OF THE DRAWINGS

FIG. 1 is a side view illustrating a rubber member supplying system pertaining to a first embodiment;

FIG. 2 is a partial perspective view illustrating the rubber member conveying part in the rubber member supplying system pertaining to the first embodiment;

FIG. 3 is a partial side view illustrating the rubber member conveying part in the rubber member supplying system pertaining to a second embodiment;

FIG. 4 is a partial perspective view illustrating the rubber member conveying part in the rubber member supplying system pertaining to the second embodiment;

FIG. 5 is a partial perspective view illustrating the rubber member conveying part in the rubber member supplying system pertaining to a third embodiment; and

FIG. 6 is a partial perspective view illustrating the rubber member conveying part in the rubber member supplying system pertaining to a fourth embodiment.

### BEST MODE EMBODIMENT OF THE INVENTION

Hereinbelow, embodiments of the present invention will be described in detail.

### First Embodiment

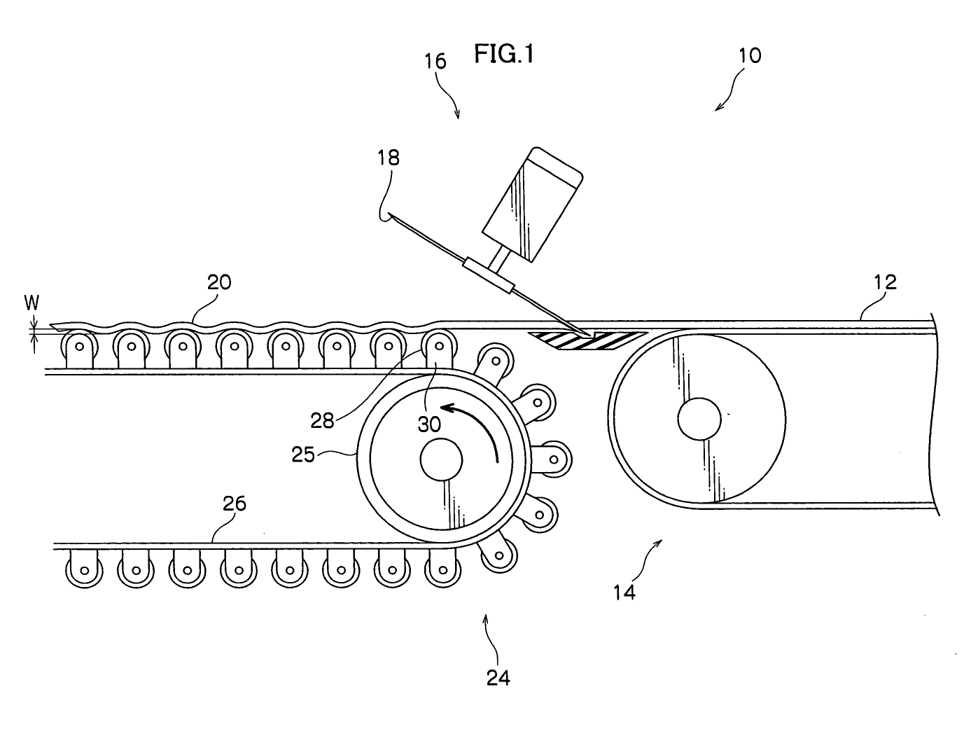

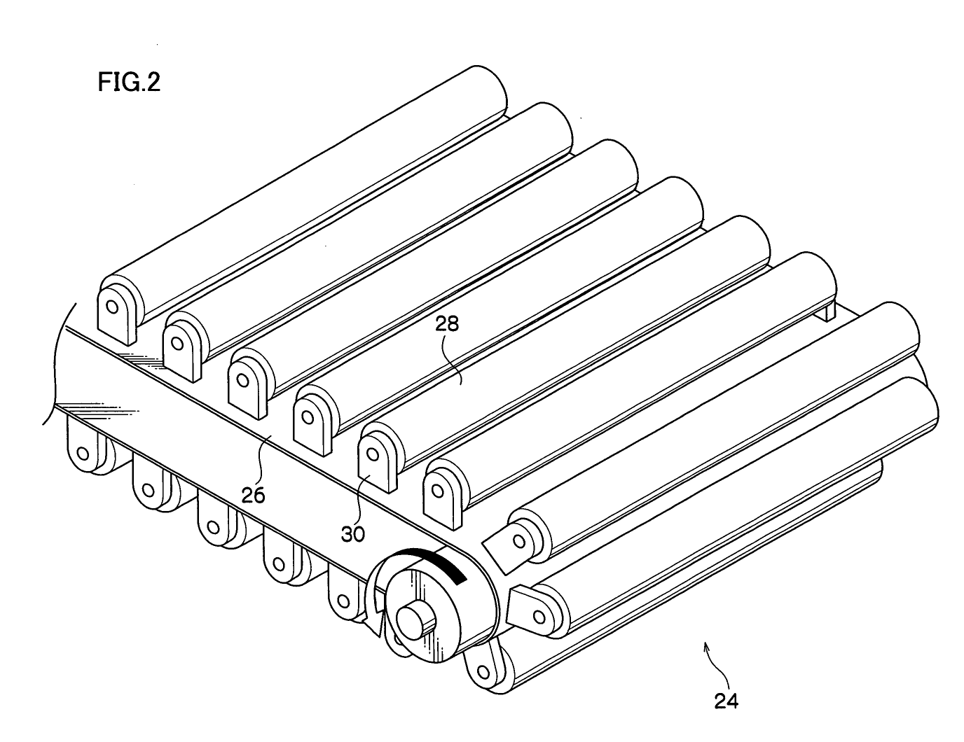

A first embodiment will be described. As shown in FIG. 1 and FIG. 2, a rubber member supplying system 10 pertaining to the present embodiment comprises a belt conveyor 14 which supplies a to-be-cut material 12 having a long strip shape and made of rubber, a cutter (sky bar) 16 which cuts the to-be-cut material 12 supplied by the belt conveyor 14, and a rubber member conveying part 24 which conveys rubber members 20 produced by cutting operation of the cutter 16.

The belt conveyor 14 is capable of intermittent running that is, the conveyance is stopped while the cutter 16 is cutting the to-be-cut material 12. In addition, the cutter 16 has a blade 18 which cuts by rotating movement, for example, and is controlled so as to cut the material 12 in a certain length.

The rubber member conveying part 24 comprises an endless belt 26 which is rotatably held by a pulley 25 at the rear end in the conveyance direction and is also held by a driving roller (not shown) at the front end in the conveyance direction. On the conveying surface side (the outer face side) of the endless belt 26, a number of rollers (free rollers) 28 are successively arranged along the conveyance direction of the endless belt 26 in a manner such that they have the axis of rotation in the width direction of the endless belt 26 (in other words, in the direction orthogonal to the conveyance direction). In addition, a number of supporting parts 30 are protruded from both side edge parts of the endless belt 26 such that they rotatably support the rollers.

Hereinbelow, the function of the rubber member supplying system 10 will be described.

After the to-be-cut material 12 being cut by the cutter 16, the belt conveyor 14 resumes conveyance of the material 12, and when the material 12 is conveyed by a certain distance, the conveyance is stopped. Then, the cutter 16 is moved to cut the to-be-cut material 12. Thus, a rubber member 20 which is cut to a certain length is provided one after another.

When the cutting is finished, the cutter 16 is moved back to an original position, and the belt conveyor 14 resumes conveyance. As a result of this, the rubber member 20 is completely transferred from the belt conveyor 14 onto the rollers 28 in the rubber member conveying part 24.

Herein, the roller 28 which is butted against the rubber member 20 is rotated by the moving force of the endless belt 26 and the friction force exerted by the rubber member 20. Therefore, the rubber member 20 is gradually conveyed at a speed much slower than the moving speed of the endless belt 26, and thus the vibration time period provided for the rubber member 20 becomes sufficiently long. In addition, the number of rollers 28 disposed cause the rubber member 20 to be conveyed while being undulated, in other words, being subjected to a minute up-and-down movement repetitively. Therefore, the rubber member 20 is exposed to vibrations at every single part thereof.

Accordingly, the rubber member 20 can be relieved of the internal strain at every single part thereof, and before the rubber member reaches to the conveyance end of the rubber member conveying part 24, the shrinkage of the rubber member 20 is substantially fully completed. Therefore, in the subsequent processing step for the rubber member 20, the length of the rubber member 20 being varied is prevented, thus the capability for processing the rubber member 20 can be markedly improved. It is noted that the rubber member conveying part 24 may be continuously run.

In addition, as described above, the conveying speed for the rubber member 20 is sufficiently slow, thus the conveying distance for the endless belt 26 can be short, and the rubber member conveying part 24 and the rubber member supplying system 10 can be rendered remarkably compact.

### EXAMPLE

In the present EXAMPLE, the diameter of the roller 28 is 20 mm; the spacing between adjacent rollers 28 is 30 mm; the length along the conveyance direction of the endless belt 26 is 2 m; and the moving speed for the endless belt 26 is 40 m/min.

As a result of these arrangements, the frequency of a vibration generated in the rubber member 20 is 20 Hz, and the amplitude (equivalent to W in FIG. 1) is 0.5 to 1.0 mm.

The to-be-cut material 12 is a long strip shaped material that is formed by the extrusion process, and the rubber member 20 provides a tread rubber member. The internal strain of the to-be-cut material 12 is practically dependent on the rubber physical properties.

According to the present EXAMPLE, if the top tread length is 2000 mm, for example, the CPK (Process Capability Index), which has conventionally been ranked at B to C, can be improved to a rank of S in the present embodiment.

### Second Embodiment

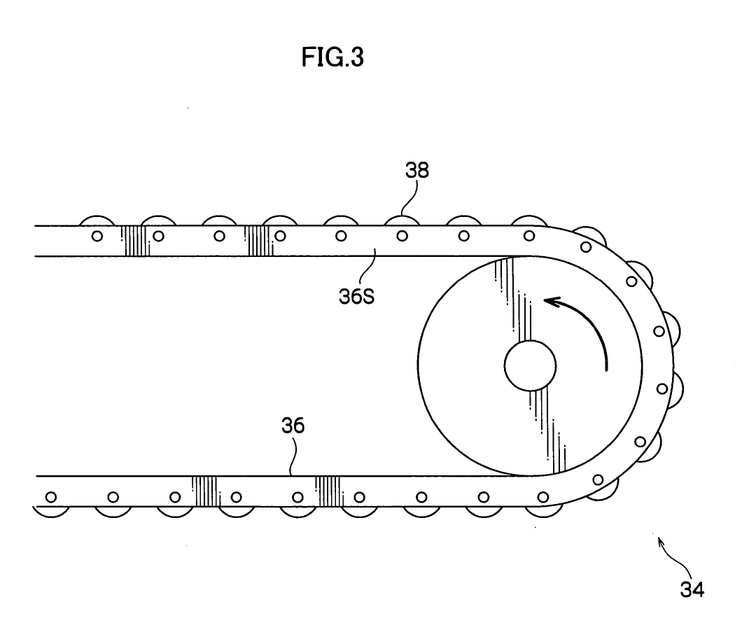

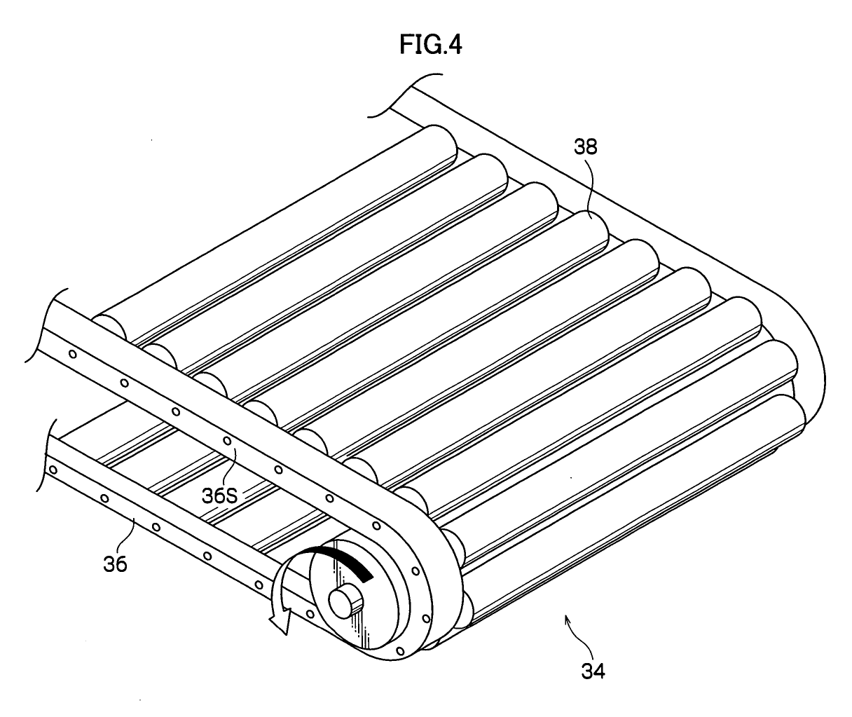

Next, a second embodiment will be described. As shown in FIG. 3 and FIG. 4, a rubber member conveying part 34 in the rubber member supplying system pertaining to the second embodiment comprises an endless belt 36 made of resin in place of the endless belt 26 (see FIG. 1 and FIG. 2) which has been described in the first embodiment. This endless belt 36 is provided with roller holding parts 36S at both ends in the width direction, and the roller holding parts 36S hold a number of rollers 38. These rollers 38 are held such that they have the axis of rotation in the width direction of the endless belt 36 (in other words, in the direction orthogonal to the conveyance direction), the roller face being exposed on the conveying face side of the endless belt 36.

In the present embodiment, as in the first embodiment, the rubber member cut to a certain length is gradually conveyed by the rubber member conveying part 34, while the rollers 38 cause the rubber member to be undulated. Therefore, the present embodiment can provide the same effects as in the first embodiment. In addition, the endless belt 36 is made of resin, thus it can be rendered more lightweight. Further, as compared to the first embodiment, there is no need for providing the supporting parts 30 (see FIG. 1 and FIG. 2) which are protruded from the endless belt 26, thus a rubber member supplying system which is simpler in configuration than the first embodiment is realized.

### Third Embodiment

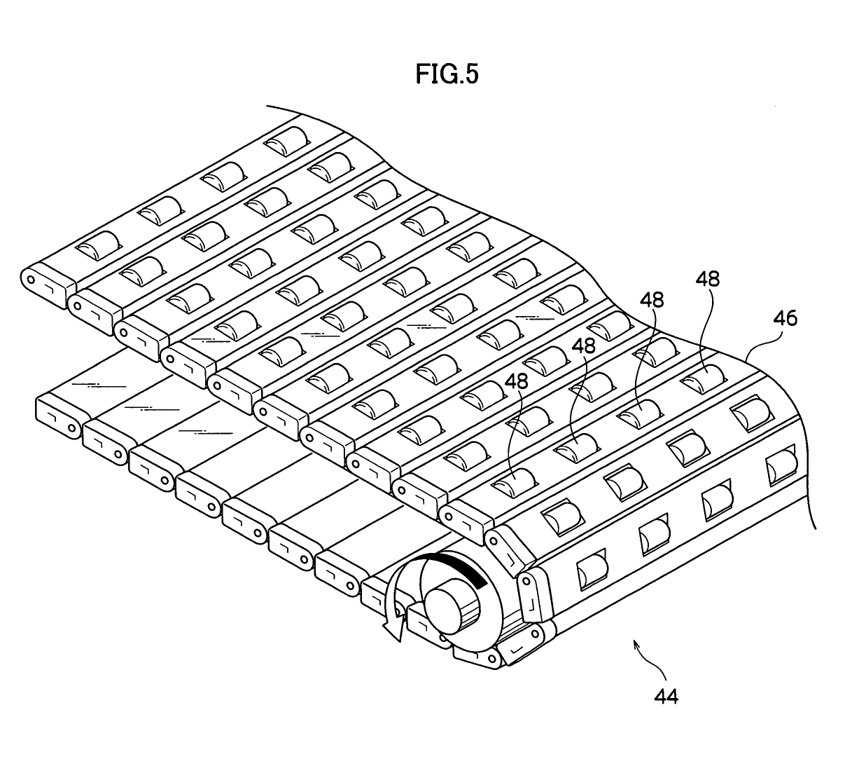

Next, a third embodiment will be described. As shown in FIG. 5, a rubber member conveying part 44 in the rubber member supplying system pertaining to the third embodiment comprises an endless belt 46 made of resin. This endless belt 46 is formed as caterpillar like and long and slender caterpillar-constituting members 50 are linked in the conveyance direction. As this endless belt 46, a commercially available item may be used.

In the respective caterpillar-constituting members 50, a plurality of rollers 48 having a short cylinder shape are rotatably held along the width direction of the endless belt 46. The axis of rotation of the roller 48 is in the direction orthogonal to the conveyance direction.

Accordingly, the same effects as in the second embodiment can be provided. In addition, if a roller 48 had a trouble, only the caterpillar-constituting member 50 holding that roller 48 need to be replaced with new one, thus the cost required for maintenance can be substantially reduced.

### Fourth Embodiment

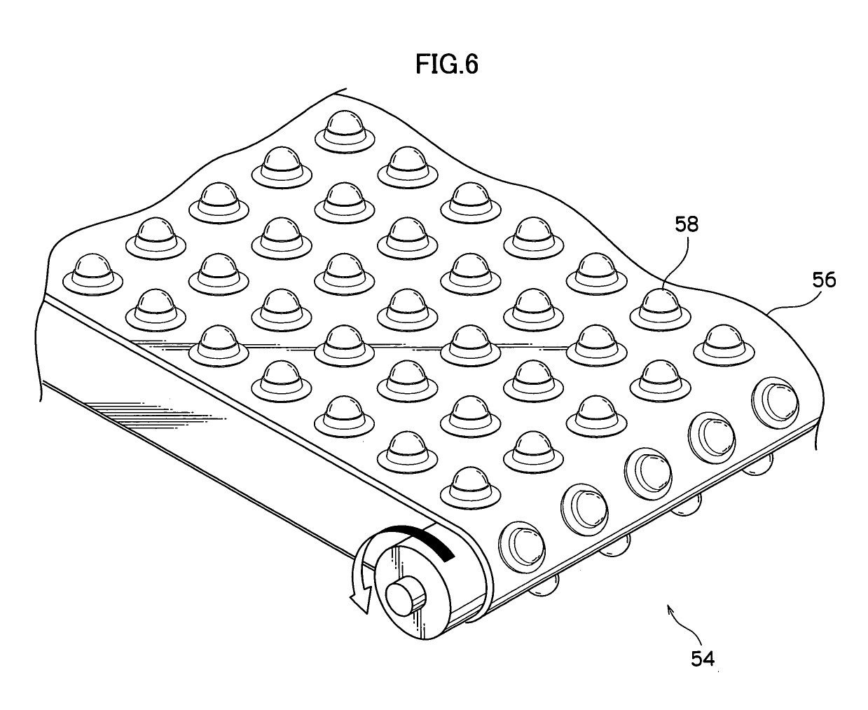

Next, a fourth embodiment will be described. As shown in FIG. 6, a rubber member conveying part 54 in the rubber member supplying system pertaining to the fourth embodiment has a lot of ball bearings 58 disposed on the conveying face side of an endless belt 56.

When a rubber member cut to a certain length is transferred onto the rubber member conveying part 54, the ball bearings 58 which are butted against the rubber member are rotated by the moving force of the endless belt 56 and the friction force exerted by the rubber member, similarly to in the first embodiment. Therefore, the rubber member is gradually conveyed at a speed much slower than the moving speed of the endless belt 56, and thus the vibration time period provided for the rubber member becomes sufficiently long. In addition, lots of ball bearings 58 disposed cause the rubber member to be conveyed while being undulated, thus the rubber member is subjected to vibrations at every single part thereof

Accordingly, as in the first embodiment, the rubber member can be relieved of the internal strain at every single part thereof. In addition, the ball bearings 58 instead of rollers are disposed on the endless belt 56, thus, like in the third embodiment, the endless belt 56 can be rendered more lightweight, and a rubber member supplying system having a simple configuration can be realized.

Hereinabove, the embodiments of the present invention have been described in detail, however, these embodiments provide only examples, and various modifications and alterations thereof may be made without departing from the scope of the present invention. In addition, it is obvious that the right of the present invention is not limited by the embodiments as described above.

### INDUSTRIAL APPLICABILITY

As described above, the rubber member conveying device and the rubber member supplying system having the same pertaining to the present invention are suited for use as a rubber member conveying device and a rubber member supplying system having the same which rapidly promote the shrinkage of the rubber member, thereby avoiding the length variation of the rubber member in the processing step for the rubber member.

### EXPLANATION OF REFERENCE NUMERALS

10: Rubber member supplying system
12: To-be-cut material
14: Belt conveyor (delivery unit)
16: Cutter (cutting unit)
20: Rubber member
24: Rubber member conveying part (rubber member conveying device)
25: Pulley (conveying part)
26: Endless belt (conveying part, endless belt)
28: Roller (vibration imparting part)
30: Supporting part (vibration imparting part)
34: Rubber member conveying part (rubber member conveying device)
36: Endless belt (conveying part, endless belt)
38: Roller (vibration imparting part)
44: Rubber member conveying part (rubber member conveying device)
46: Endless belt (conveying part, endless belt)
48: Roller (vibration imparting part)
54: Rubber member conveying part (rubber member conveying device)
56: Endless belt (conveying part, endless belt)
58: Ball bearing (vibration imparting part)

What is claimed is:

1. A rubber member conveying device comprising:
a vibration imparting part that imparts vibration to a rubber member having internal strain; and
a conveying part that conveys the rubber member; wherein the rubber member is conveyed by the conveying part while having vibration imparted thereto by the vibration imparting part.

2. The rubber member conveying device of claim 1, wherein the vibration imparted to the rubber member has a frequency of 5 to 100 Hz, an amplitude of 0.5 to 10 mm, and a time period of vibration of 1 sec or longer.

3. The rubber member conveying device of claim 2, wherein the frequency, the amplitude, and the time period of vibration are set according to the thickness, hardness and amount of internal strain of the rubber member.

4. The rubber member conveying device of any one of claims 1 to 3, wherein
the conveying part is provided with a rotating endless belt that is loaded with the rubber member,
a protruding part is provided as the vibration imparting part on a rubber member loading surface side of the endless belt, and
the rubber member is moved relatively to the protruding part due to rotation of the endless belt.

5. The rubber member conveying device of claim 4 wherein,
a plurality of revolving elements that are held freely rotatably are provided as the protruding part, and
when the endless belt rotates, the revolving elements that are butted against the rubber member are turned by a moving force of the endless belt and a friction force exerted by the rubber member.

6. The rubber member conveying device of claim 5, wherein, as the revolving elements, rollers are provided such that an axis of rotation thereof is in a direction orthogonal to a conveyance direction.

7. The rubber member conveying device of claim 5, wherein the revolving elements are ball bearings.

8. A rubber member supplying system, comprising:
a delivery unit that delivers a to-be-cut material made of rubber having internal strain;
a cutting unit that cuts the to-be-cut material supplied by the delivery unit; and
the conveying device of any one of claims 1 to 7 that conveys a rubber member that has been cut by the cutting unit.

9. The rubber member supplying system of claim 8, wherein the delivery unit is capable of intermittent running, and when the cutting unit cuts the to-be-cut material, the delivery unit stops delivery of the to-be-cut material.

10. The rubber member supplying system of claim 8 or 9, wherein the to-be-cut material has a long strip shape that is formed by an extrusion process.
